(19) United States
(12) Patent Application Publication
(10) Pub. No.: US 2004/0255315 A1
(43) Pub. Date: Dec. 16, 2004

(54) Fixing apparatus for an optical pick-up

(76) Inventor: Pin-Shih Chean, Taipei (TW)

Correspondence Address: Han-Yi Lee, BAYSHORE PATENT GROUP, LLC, 520 Chantecler Dr., Fremont, CA, 94539, US

(21) Appl. No.: 10/746,761

(22) Filed: Dec. 26, 2003

(30) Foreign Application Priority Data
Jun. 11, 2003 (TW) 092210636

(51) Int. Cl. G11B 17/00

(52) U.S. Cl. 720/671; 720/688

(57) ABSTRACT

A fixing apparatus for an optical pick-up, which is able to be placed on a tray of a compact disk drive for fixing the optical pick-up, and the fixing apparatus includes a flat plate and a stop piece. The flat plate is placed on the tray and held firmly on top of the tray and the stop piece is installed on a surface of the flat plate for stopping the movement of the optical pick-up. Hence, the fixing apparatus can avoid any damages to the optical pick-up when the compact disk drive is under external shock or falling impact during being delivered.

### FIELD OF THE INVENTION

The present invention relates to a protective device for optical pick-up and particularly to a fixing apparatus for the optical pick-up, whose function is to prevent the optical pick-up from receiving damages when the compact disk drive is under external shock or falling impact during the optical pick-up being delivered.

### BACKGROUND OF THE INVENTION

An Optical pick-up apparatus disclosed in U.S. Pat. No. 5,787,067 reveals an optical pick-up with a damper to absorb external shock so as to prevent the object lens from swinging and moving. Meanwhile, the damper is used for connecting both the yoke plate and the object lens holder and thus by this means to achieve the goal of absorbing external shock and preventing the object lens from swinging and moving. However, a major disadvantage of the prior art is in that the surrounding structure of the optical pick-up has to be modified and it is incapable of being implemented on the existing compact disk drives directly.

### SUMMARY OF THE INVENTION

The main objective of the present invention is to provide a fixing apparatus for an optical pick-up so as to prevent the optical pick-up from damaging itself when the compact disk drive is under external shock or falling impact during being delivered.

In order to achieve the preceding objective, the present invention provides a fixing apparatus, which can be placed on a tray of the compact disk drive to fix the optical pick-up in place and thus preventing any damages to the optical pick-up when the compact disk drive is under external shock or falling impact during being delivered. The fixing apparatus includes a flat plate, which is placed on top of the tray of the compact disk drive and is fixed onto the tray, a stop piece, which is disposed under surface of the flat plate for preventing the optical pick-up from moving.

### BRIEF DESCRIPTION OF THE DRAWINGS

The present invention can be more fully understood by reference to the following description and accompanying drawings, in which:

FIG. 1 is a perspective view illustrating a CD drive attached with a fixing apparatus according to the present invention;

FIG. 2 is a perspective view of the fixing apparatus according to the present invention; and

FIG. 3 is a plan view illustrating the fixing apparatus of the present invention stopping the optical pick-up.

### DETAILED DESCRIPTION OF THE INVENTION

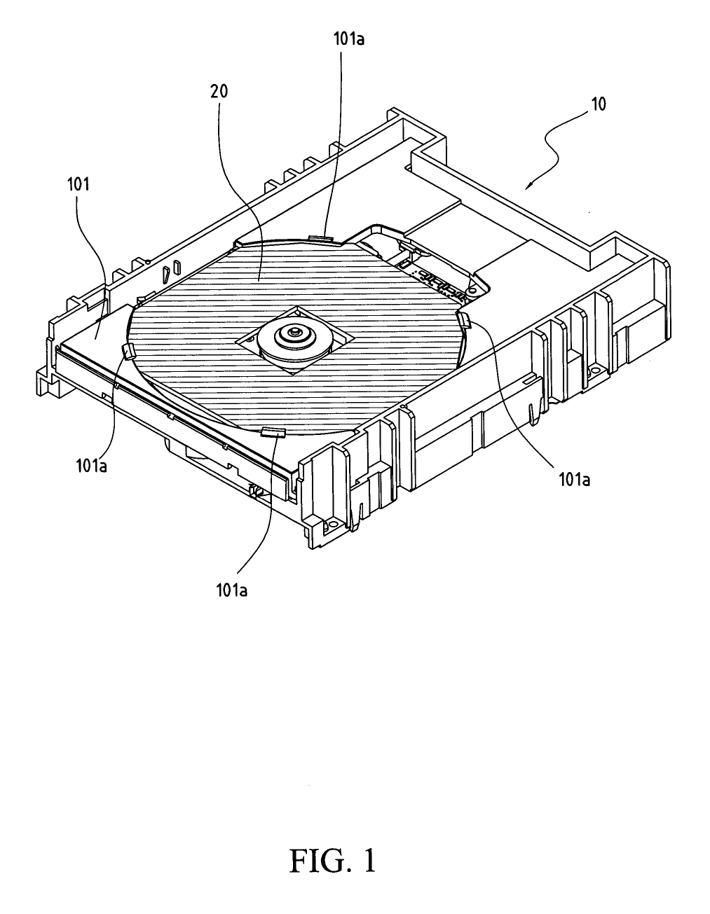

Referring to FIG. 1, a perspective view illustrates a CD drive attached with a fixing apparatus of the present invention. The fixing apparatus 20 is placed in the tray 101 of the CD drive 10 and making use of the holding element 101a on the tray 101 to stabilize and hold the fixing apparatus 20 firmly in the tray 101.

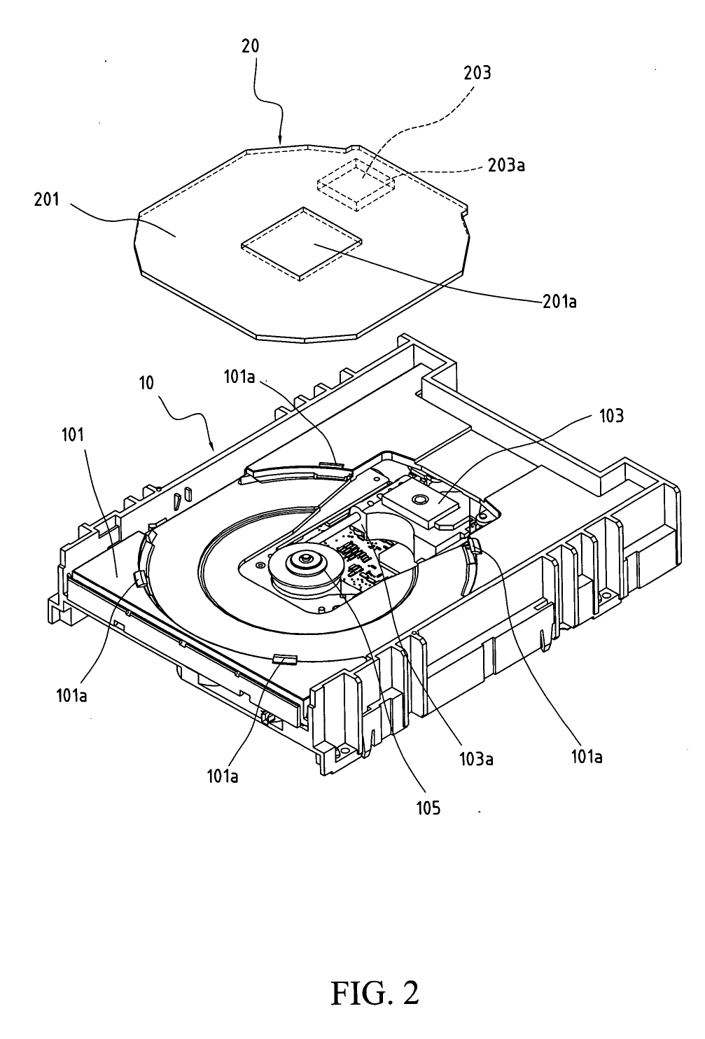

Referring to FIG. 2, a perspective view of the fixing apparatus according to the present invention is illustrated. The fixing apparatus 20 primary includes a flat plate 201 and a stop piece 203. The flat plate 201 is placed on top of the tray 101 and due to the holding effect of the holding element 101a on the flat plate 201, the placed flat plate 201 is held firmly on the tray 101. Therefore, even if the CD drive 10 experienced external shock or falling impact, the flat plate 201 is capable of not falling off. The stop piece 203 is positioned on the surface of the flat plate 201 to prevent the movement of the optical pick-up 103 caused by external shock or falling impact. The flat plate 201 further installs a hole-like central area 201a where it allows the motor of the main shaft 105 of the CD drive 10 to successfully pass through the central area 201a when the flat plate 201 is placed on the tray 101.

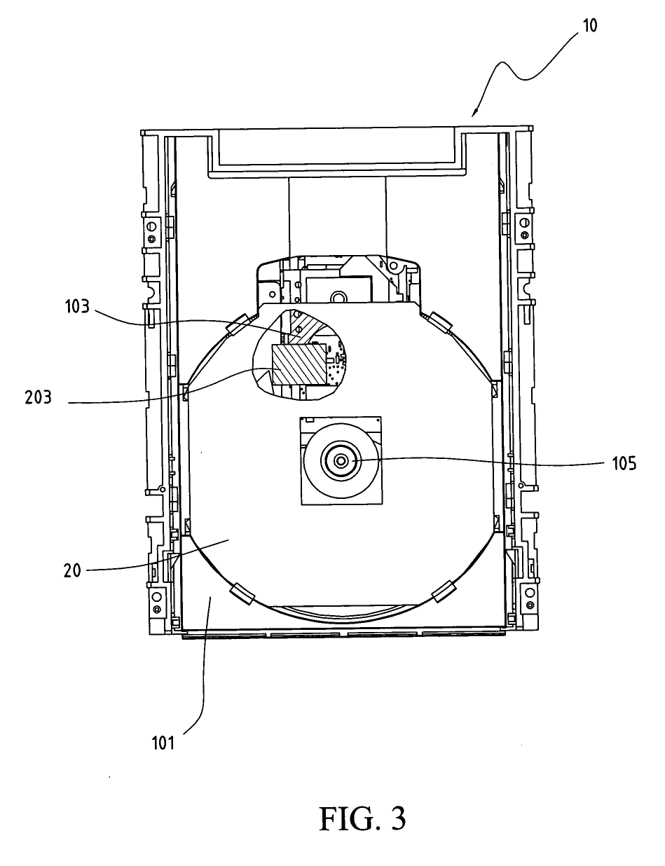

Referring to FIG. 3, a plan view illustrates the fixing apparatus of the present invention stopping the optical pick-up. The lateral wall 203a of the stop piece 203 is stopped at the lateral side 103a of the optical pick-up 103. Since the stop piece 203 is fixed on the surface of the flat plate 201 while the flat plate 201 is firmly held in the tray 101, therefore, in the situation of the CD drive 10 experiencing external shock or falling impact during the transportation process, the extremely delicate optical pick-up 103 can be stopped and incapable of moving, thus, completely avoid the damages being done on the optical pick-up 103.

The flat plate 201 according to the present invention can be made of cardboard in an actual implementation while the material for the stop piece can be made of foam.

While the invention has been described with reference to the a preferred embodiment thereof, it is to be understood that modifications or variations may be easily made without departing from the spirit of this invention, which is defined by the appended claims.

What is claimed is:

1. A fixing apparatus for an optical pick-up, being able to be placed on a tray of a compact disk drive for fixing the optical pick-up, comprising:
a flat plate, being placed on the tray and held firmly on top of the tray; and
a stop piece, being installed on a surface of the flat plate for stopping the movement of the optical pick-up;
whereby, the fixing apparatus can avoid any damages to the optical pick-up when the compact disk drive is under external shock or falling impact during being delivered.

2. The fixing apparatus as defined in claim 1, wherein the flat plate further comprises a central area that forms an opening.

3. The fixing apparatus as defined in claim 1, wherein the flat plate can be made of cardboard.

4. The fixing apparatus as defined in claim 1, wherein the stop piece is made of foam.

5. The fixing apparatus as defined in claim 1, wherein a lateral wall of the stop piece s tops one of two lateral sides of the optical pick-up.
